(19) United States
(12) Patent Application Publication
(10) Pub. No.: US 2019/0243129 A1
(43) Pub. Date: Aug. 8, 2019

(54) SIGHT GLASS COVER WITH INTEGRATED CLEANING DEVICE

(71) Applicant: Bayer Aktiengesellschaft, Leverkusen (DE)

(72) Inventor: Andreas SZALOKI, Koeln (DE)

(21) Appl. No.: 16/316,492

(22) PCT Filed: Jul. 6, 2017
(86) PCT No.: PCT/EP2017/066947

§ 371 Date: Jan. 9, 2019

(30) Foreign Application Priority Data
Jul. 11, 2016 (EP) 16178810.4

(51) Int. Cl. G02B 27/00; B01J 3/00; G02B 7/00

(52) U.S. Cl. CPC G02B 27/0006; B08B 3/02; G02B 7/007; B01J 3/004

(57) ABSTRACT

The invention relates to a sight glass cover (10) with an integrated cleaning device, for closing an opening (14), comprising a sight glass (18), which has a glass edge (57) and a glass inner side (20), wherein the glass inner side (20) is facing the opening (14) when a sight glass cover (10) is placed on the opening (14), and a frame device (16), which encloses the sight glass (18) at least in the region of the glass edge (57), wherein the frame device (16) has a frame inner side (32), which is facing away from the glass inner side (20) and lies against a wall region 34 surrounding the opening (14) when a sight glass cover (10) is placed on the opening (14), a cleaning device (22), which is formed in the frame device (16) and has at least one channel (24) with an inlet opening (26) and an outlet opening (28) at a distance from the inlet opening (26), wherein the outlet opening (28) of the channel (24) is formed between the glass inner side (20) and the frame inner side (32), and the channel (24) is designed and formed in such a way that the glass inner side (20) of the sight glass (18) can be at least partially wetted with a medium (30) fed into the channel (24) by way of the inlet opening (26) and leaving by way of the outlet opening (28). This is a way of providing a cover with a sight glass in the case of which the sight glass can be cleaned in a closed state of the cover with little effort.

The present invention relates to a sight glass cover with an integrated cleaning device for cleaning the sight glass. The invention also relates to the use of the sight glass cover according to the invention in a chemical production plant for closing a vessel and/or a pipe of the chemical production plant.

It is generally known that vessels and/or pipes of chemical production plants have openings that are closed by a cover. It is also known that such covers have a sight glass, in order to observe any processes within the vessel and/or the pipe. During a production process or after a series of production processes, it may however happen that the inner side of the sight glass of a cover is soiled or that deposits are left on the inner side of the sight glass of the cover, so that observation of the interior of the vessel and/or pipe through the sight glass is no longer possible, or only to a restricted extent.

Usually, soiled glasses are cleaned by the cover being removed from the vessel and the inner side of the sight glass that is facing the interior of the vessel being cleaned manually. After that, the cover with the cleaned sight glass is replaced on the vessel and fastened. A disadvantage of such a method is that, for instance for safety reasons, cleaning of the cover can generally only take place during breaks in production. What is more, the cover must be removed for cleaning, which means additional expenditure of time. Furthermore, it may happen that the fastening device of the cover becomes prematurely worn due to regular loosening and fastening of the cover for cleaning the sight glass, or likewise the seals become damaged during the cleaning operations, which can lead to increased costs.

U.S. Pat. No. 4,541,277 describes a sight glass cover in which a flushing channel is formed by a bore in the cover, the flushing channel opening out in a flushing chamber. The flushing chamber has a simple opening-forming element (covers 21, 22), from which the flushing liquid flows out of the flushing chamber without pressure.

U.S. Pat. No. 3,848,961 describes a sight glass cover in the case of which a nozzle cone is used for cleaning the window glass centrally from the inside outward. For distributing the liquid, pressure is applied laterally and on one side over the window glass. This solution can only be used for small surface areas and requires the introduction of the nozzle cone at a central location.

The object of the invention is consequently that of providing a cover with a sight glass and an integrated cleaning device in the case of which the sight glass can be cleaned with little effort, wherein the solution can be easily produced, is intended to be suitable for sight glasses of various sizes. The solution should be adaptable in such a way that, if required, a cleaning medium can be introduced with higher kinetic energy.

This object is achieved by the independent patent claims. The dependent patent claims describe preferred developments of the invention.

According to the invention, a sight glass cover with an integrated cleaning device, for closing an opening, is provided, comprising a sight glass, which has a glass edge and a glass inner side, wherein the glass inner side is facing the opening when a sight glass cover is placed on the opening, and a frame device, which encloses the sight glass at least in the region of the glass edge, wherein the frame device has a frame inner side, which is facing away from the glass inner side and lies against a wall region surrounding the opening when a sight glass cover is placed on the opening, a cleaning device, which is formed in the frame device and has at least one channel with an inlet opening and an outlet opening at a distance from the inlet opening, wherein the outlet opening of the channel is formed between the glass inner side and the frame inner side, and the channel is designed and formed in such a way that the glass inner side of the sight glass can be at least partially wetted with a medium fed into the channel by way of the inlet opening and leaving by way of the outlet opening. This is a way of providing a sight glass cover with an integrated sight glass and an integrated cleaning device for cleaning the sight glass in the case of which the glass inner side can be at least partially wetted by the medium being fed into the channel by way of the inlet opening and the medium leaving by way of the outlet opening, whereby contaminants on the inner side can be removed. The feeding of the medium can in this case take place from the outside when a sight glass cover is mounted on the opening. Consequently, cleaning of the glass inner side of the sight glass during a production process is possible in an easy and convenient way.

A sight glass is preferably understood as meaning a transparent material through which a person can look. Preferably, the sight glass is a sheet of plastic or of glass. The sight glass may in this case be designed in such a way that it withstands temperature fluctuations and/or pressure fluctuations and/or is acid-resistant. With particular preference, the sight glass meets safety requirements for closure devices for chemical production plants. It is also provided with preference that the sight glass has a coating and/or a tinting. The coating may serve the purpose that dirt particles on the sight glass have less of a hold or attach themselves less strongly, and the sight glass can consequently be cleaned better or more easily. The tinting is particularly advantageous if a UV-proof closure of a vessel and/or pipe of the chemical production plant by a sight glass cover is required.

A medium is understood as meaning such a medium that is suitable for performing cleaning of the inner side of the sight glass. Preferably, such a medium is a fluid medium, such as preferably water and/or a cleaning agent. The cleaning agent may preferably be a chemical cleaning agent.

Alternatively or in addition to the water or cleaning agent, the medium may also be air, so that preferably dust-like or stubborn deposits on the glass inner side of the sight glass can be removed by way of a corresponding air pressure. In principle, the cleaning agent must be compatible with the content of the reactor.

In principle, the channel within the frame device may be formed variously.

In a preferred development of the invention, it is provided that the frame device has a frame outer edge and a frame inner edge at a distance from the frame outer edge, wherein the frame inner edge is facing the sight glass and the frame outer edge is facing away from the sight glass, and the channel runs from the frame outer edge to the frame inner edge, and the inlet opening is formed on the frame outer edge, and the outlet opening is formed on the frame inner edge. In this way, the channel runs from the frame outer edge to the frame inner edge. Consequently, a medium can be introduced into the channel from outside the sight glass cover by way of the inlet opening formed in the frame outer edge, whereby convenient feeding in of the medium is provided. The formation of the inlet opening in the frame outer edge may also be particularly advantageous because it is consequently arranged at a side edge of the sight glass cover. Any devices at the inlet opening can consequently be protected from external effects. Preferably, the channel runs toward the center of the sight glass, typically in a straight line. For example, in the case of a circular frame, the channel runs in a straight line along the radius.

In this connection, a preferred development of the invention provides that the channel is formed from the frame outer edge to the frame inner edge in a straight line. The channel may consequently be produced by a bore that runs from the frame outer edge to the frame inner edge. Such a bore can be produced with little effort and is consequently inexpensive.

An advantageous development of the invention provides that the inlet opening of the channel has a connecting branch. The connecting branch makes it easily possible to connect a hose, by means of which the medium can be directed by way of the inlet opening into the channel up to the outlet opening. It is provided with particular preference that the connecting branch has a valve. In this way, the inflow of the medium can be regulated and/or controlled by means of the valve. Preferably, in this way the pressure with which the medium wets the glass inner side of the sight glass can be regulated.

According to a preferred development of the invention, it is provided that the outlet opening of the channel has on the frame inner side a nozzle device with a nozzle. The nozzle may in this case be formed in such a way that the medium impinges on the glass inner side of the sight glass at a certain angle and/or with a certain atomization. In this way, the cleaning effect of the sight glass can be increased. What is more, the nozzle may be formed in such a way that an ingress of particles into the channel by way of the nozzle is reduced or avoided. This is preferably controlled by means of the diameter of the nozzle.

In an advantageous development of the invention, it is provided that the nozzle device has a nozzle frame with a distributor channel and a plurality of nozzles connected to the distributor channel, and the nozzle frame is arranged and/or fastened on the frame inner edge in such a way that the outlet opening of the channel arranged on the frame inner edge opens out into the distributor channel, and the nozzles are arranged and formed in such a way that, when a nozzle cover is placed on an opening and closes the opening, the glass inner side of the sight glass can be at least partially wetted with a medium fed in by way of the inlet opening and leaving by way of the nozzles. This is a way of providing a cleaning device in the case of which the channel opens out into a distributor channel of the nozzle frame. From this distributor channel, there extend a plurality of nozzles, by way of which the medium can be delivered onto the glass inner side of the sight glass. This provides a cleaning device which makes it possible for the inner side of the sight glass to be wetted as far as possible over its full surface area by way of a channel.

The number and arrangement of the outlet openings on the frame inner edge is chosen with preference in such a way that the medium can be introduced over the inner side of the sight glass from several sides, in an area-covering manner and, due to the arrangement, in an area-overlapping manner.

In principle, the nozzle frame may be formed and arranged in various ways. In a preferred development of the invention, it is provided that the nozzle frame has a nozzle frame inner edge and a nozzle frame outer edge at a distance from the nozzle frame inner edge and the nozzle frame is arranged with its nozzle frame outer edge at least partially on the frame inner edge, and the nozzle frame inner edge is facing away from the frame inner edge, and the distributor channel is preferably formed as running around peripherally on the nozzle frame outer edge, and the plurality of nozzles respectively run from the distributor channel to the nozzle frame inner edge. With preference, the nozzle frame is in this case welded on the frame inner edge.

The distributor channel of the nozzle frame outer edge may be formed in various ways. In a preferred development of the invention, it is provided that the distributor channel formed in the nozzle frame outer edge is preferably a peripheral groove or a peripheral hollow fillet. In principle, the distributor channel may, however, have any profile that makes it possible for the medium to be distributed by way of the distributor channel to the nozzles.

In a preferred development of the invention, it is provided that the outlet opening of the channel and the nozzles of the nozzle frame are arranged offset in relation to one another. Owing to the offset arrangement of the channel and nozzles, the medium that enters by way of the inlet opening of the channel and leaves by way of the outlet opening of the channel is forced to flow first into the distributor channel. From this distributor channel, the medium flows out by way of the various nozzles and wets the glass inner side of the sight glass. In this way, uniform feeding of the medium to the nozzles can be made possible, and greatest possible wetting of the glass inner side can be accomplished.

According to an advantageous development of the invention, it is provided that the glass inner side of the sight glass has a level surface and the channel and/or the outlet opening and/or the nozzle is arranged and/or aligned with respect to the glass inner side at an angle α of between 10°≤α≤60°, preferably 10°≤α≤45°, and most preferably 10°≤α≤30°. This is a way of providing an angular range for different dimensions for the size of the sight glass or the diameter of the sight glass and the distance from the outlet opening or the nozzle to the glass inner side of the sight glass that makes greatest possible wetting of the glass inner side possible, so that wetting of the glass inner side of the sight glass as far as possible over its full surface area can be accomplished. A small angle of between 10°≤α≤30° is preferably suitable for a frame device of a small overall height. In this way, a flat sight glass cover with an integrated cleaning device can be provided.

The frame device may have various or different forms. In a preferred development of the invention, it is provided that the frame device is formed in the form of a circular ring. A sight glass, formed in the form of a circular ring, is preferably suitable for closing a manhole in a vessel and/or pipe of a chemical production plant. A manhole is understood as meaning an opening in a device, preferably a vessel or a pipe, of such a size that a person can climb through the manhole or the opening.

The sight glass may be arranged in the frame device in various ways. Preferably, similar to a windowpane in a window frame, the sight glass is enclosed in the frame device. The frame device may in this case be formed as rectangular or circular. In a preferred development of the invention, it is provided that the frame device has a frame outer side, which is arranged at a distance from the frame inner side and is facing away from the wall region surrounding the opening when a sight glass cover is placed on the opening, and a profiling is formed in a transitional region between the frame outer side and the frame inner edge, wherein the profiling is designed and formed for receiving the sight glass at least partially, preferably in a peripheral region of the glass edge. In this way, the sight glass lies at least partially with the glass inner side in the peripheral region of the glass edge in the profiling. It is preferably provided that a sealing material is arranged between the sight glass and the profiling. The sealing material brings about a sealing effect between the sight glass and the frame device. What is more, damage to the sight glass can be reduced or avoided by the sealing material.

The sight glass may be adhesively bonded in the profiling, in order to connect it to the frame device. In a preferred development of the invention, it is provided that the sight glass can be fixed in the profiling of the frame device by means of a flange placed on the frame outer side. By means of this flange, the peripheral region of the sight glass in the region of the glass edge is pressed into the profiling, so that the sight glass is fixed securely in position in the frame device.

The sight glass cover may be fastened onto a vessel and/or a pipe in various ways. In a preferred development of the invention, it is provided that the frame device has at least one bore passing through from the frame outer side to the frame inner side. Consequently, the frame device has a bore which is designed for receiving a fastening means in order to fasten or flange-mount the sight glass cover over an opening arranged in a vessel and/or pipe.

In principle, it is sufficient if the frame device has one channel for introducing a medium into the channel by way of the inlet opening and discharging it by way of the outlet opening in such a way that the glass inner side of the sight glass is at least partially wetted. In a preferred development of the invention, it is provided that the frame device has a plurality of channels. In this way, the glass inner side of the sight glass can be wetted from different directions individually by way of the plurality of channels, wherein each channel can be individually activated. This is comparable with a nozzle frame that has a distributor channel and a plurality of nozzles extend from the distributor channel. However, in the case of a nozzle frame with a distributor channel, the respective nozzles cannot be individually activated.

Finally, a preferred development of the invention provides that the plurality of nozzles and/or the plurality of outlet openings are arranged at equal distances from one another. In this way, uniform wetting of the glass inner side of the sight glass is made possible, whereby the cleaning effect can be increased.

The invention also relates to the use of a sight glass cover with an integrated cleaning device, comprising a sight glass, which has a glass edge and a glass inner side, wherein the glass inner side is facing the opening when a sight glass cover is placed on the opening, and a frame device, which encloses the sight glass at least in the region of the glass edge, wherein the frame device has a frame inner side, which is facing away from the glass inner side and lies against a wall region surrounding the opening when a sight glass cover is placed on the opening, a cleaning device, which is formed in the frame device and has at least one channel with an inlet opening and an outlet opening at a distance from the inlet opening, wherein the outlet opening of the channel is formed between the glass inner side and the frame inner side, and the channel is designed and formed in such a way that the glass inner side of the sight glass can be at least partially wetted with a medium fed into the channel by way of the inlet opening and leaving by way of the outlet opening, for closing an opening in a vessel and/or pipe of a chemical production plant. This is a way of providing a sight glass cover with a sight glass designed for closing a vessel and/or pipe of a chemical production plant that has a cleaning device with which the sight glass of the sight glass cover can be cleaned in an easy way.

It goes without saying that advantageous development of the sight glass cover according to the invention likewise relate to the use of the sight glass cover according to the invention.

The invention is explained below by way of example with reference to the accompanying figures on the basis of preferred exemplary embodiments, and the features specified below may constitute an aspect of the invention either on their own or in combination with one another. In the figures:

FIG. 1: shows a vertical section through a sight glass cover with an integrated cleaning device according to a preferred exemplary embodiment of the invention,

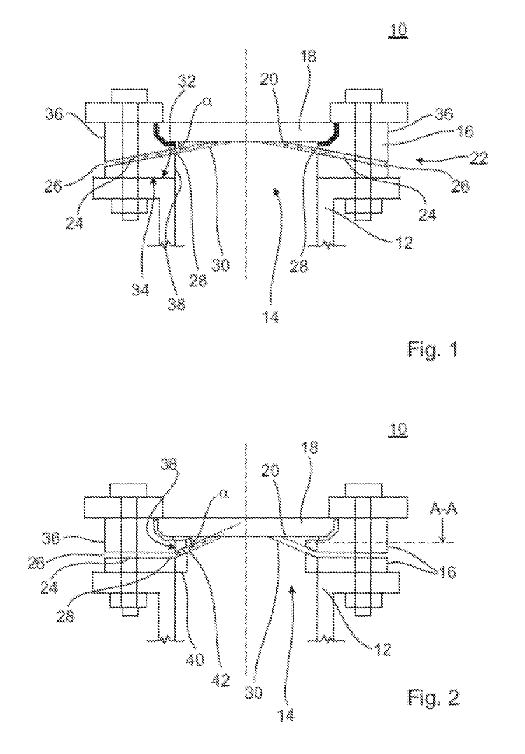

FIG. 2: shows a vertical section through the sight glass cover with a nozzle device according to the preferred exemplary embodiment of the invention,

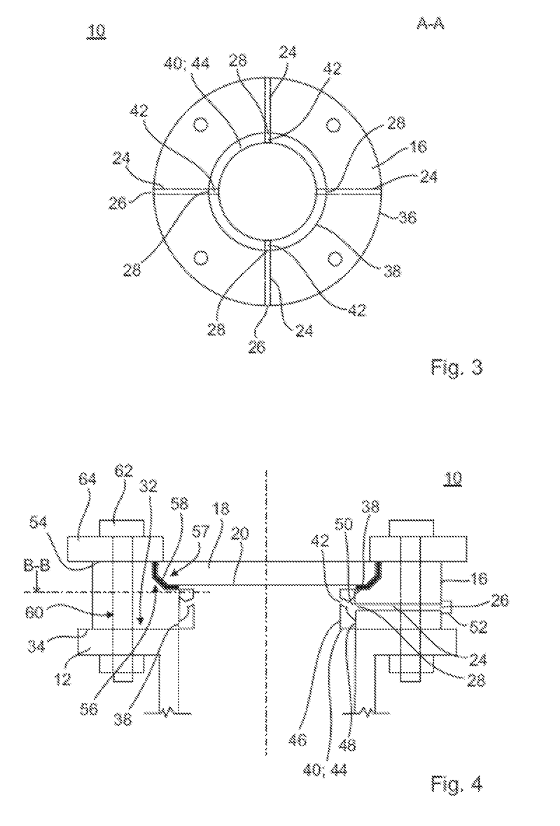

FIG. 3: shows a horizontal section through a frame device of the sight glass cover, with an integrated cleaning device with a number of channels and a nozzle device according to the preferred exemplary embodiment of the invention,

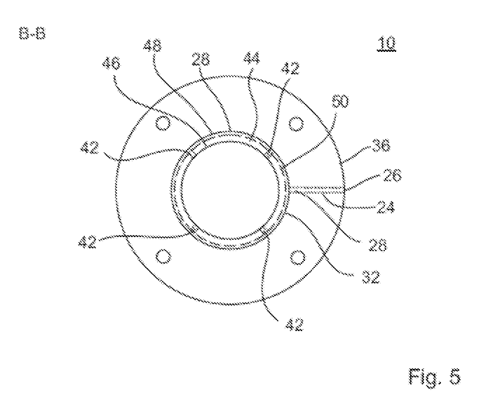

FIG. 4: shows a vertical section through the sight glass cover with a nozzle device formed in a frame-like manner according to the preferred exemplary embodiment of the invention, and

FIG. 5: shows a horizontal section through the frame device of the sight glass cover with only one channel and one distributor channel in a nozzle frame of the nozzle device according to the preferred exemplary embodiment of the invention.

In FIG. 1, a vertical section through a sight glass cover 10 with an integrated cleaning device is shown. The sight glass cover 10 is flange-mounted on a pipe end portion 12, which has an opening 14, and consequently closes the opening 14 of the pipe end portion 12. It can also be seen that the sight glass cover 10 comprises a frame device 16 with a sight glass 18 enclosed by the frame device. The sight glass 18 has a glass inner side 20, which is facing the opening 14 of the pipe end portion 12. The frame device 16 has a frame inner side 32, which is facing away from the glass inner side 20 and is facing a wall area 34 of the pipe end portion 12 surrounding the opening 14 when a sight glass cover 10 is closing the opening 14. A cleaning device 22, which comprises a channel 24 that has an inlet opening 26 and an outlet opening 28 at a distance from the inlet opening 26, is formed in the frame device 16. The outlet opening 28 is arranged between the glass inner side 20 and the frame inner side 32. A medium 30 is fed to the channel 24 by way of the inlet opening 26, leaves by way of the outlet opening 28 and at least partially wets the glass inner side 20 of the sight glass 18. This is a way of providing a sight glass cover 10 with an integrated cleaning device 22 in the case of which the glass inner side 20 of the sight glass 18 can be cleaned in an easy way with a medium 30 introduced into the channel 24 by way of the inlet opening 26 when the sight glass cover 10 is closed.

Furthermore, the frame device 16 has a frame outer edge 36 and a frame inner edge 38 arranged parallel to and at a distance from the frame outer edge 36. The frame inner edge 38 is facing the sight glass 18 and the frame outer edge 36 is facing away from the sight glass 18. The channel 24 extends from the frame outer edge 36 to the frame inner edge 38 and has a straight path, which is formed by a bore. The inlet opening 26 is formed on the frame outer edge 36 and the outlet opening 28 is arranged on the frame inner edge 38.

In order to wet the glass inner side 20 of the sight glass 18 with the medium 30 as far as possible over its full surface area, the channel 24 and the outlet opening 28 are arranged at an angle α=10° in relation to the plane of the glass inner side 20 of the sight glass 18.

In FIG. 2, a further variant of the sight glass cover 10 with an integrated cleaning device 22 is shown. By analogy with the sight glass cover 10 shown in FIG. 1, the sight glass cover 10 is flange-mounted on a pipe end portion 12 and closes the opening 14 of the pipe end portion 12. The channel 24 extends from the frame outer edge 36 to the frame inner edge 38 in a straight line. As a difference from the example shown in FIG. 1, the channel 24 is not arranged at an angle α of 10° in relation to the plane of the glass inner side 20 of the sight glass 18. The channel 24 runs substantially parallel to the plane of the glass inner side 20 of the sight glass 18. A nozzle device 40 with a nozzle 42 is arranged on the outlet opening 28 formed at the frame inner edge 38. The nozzle 42 is arranged or formed with respect to the plane of the glass inner side 20 of the sight glass 18 at an angle α=15°, in order to spray the medium 30 introduced into the channel 24 by way of the inlet opening 26 and the medium 30 leaving the nozzle 42 onto the glass inner side 20 of the sight glass 18.

The direction in which the medium 30 is applied to the glass inner side 20 of the sight glass 18 depends on the angular setting of the nozzle 42. In this way, the channel 24 can be formed within the frame device 16 substantially independently of the plane of the glass inner side 20 of the sight glass 18.

In FIG. 3, a horizontal section through the frame device 16 is shown. The frame device 16 is formed as a circular ring and serves for closing a manhole in a vessel of a chemical production plant. Altogether, arranged at regular intervals from one another in the frame device 16 are four channels 24, which in each case extend radially from the frame outer edge 36 to the frame inner edge 38. A nozzle device 40 in the form of a nozzle frame 44 is arranged on the frame inner edge 38. The nozzle frame 44 has a plurality of nozzles 42, which adjoin the respective outlet openings 28. In this way, a medium 30 can be introduced into the respective channels 24 by way of the various inlet openings 26 and be sprayed by means of the nozzles 42, so that a wetting of the glass inner side of the sight glass (which cannot be seen in this section) as far as possible over its full surface area is made possible.

In FIG. 4, the sight glass cover 10 known from FIG. 2 is shown. As a difference from FIG. 2, the frame device 16 has only one channel 24 with an inlet opening 26 and an outlet opening 28. Furthermore, the nozzle frame 44 has a nozzle frame inner edge 46 and a nozzle frame outer edge 48, arranged parallel to and at a distance from the nozzle frame inner edge 46. The nozzle frame 44 is arranged with the nozzle frame outer edge 48 at least partially on the frame inner edge 38 and the nozzle frame inner edge 46 is facing away from the frame inner edge 38. The nozzle frame 44 has a distributor channel 50, which is arranged running around peripherally on the nozzle frame outer edge 48. From the distributor channel 50 there extend a plurality of nozzles 42 to the nozzle frame inner edge 46. In this way, a number of nozzles 42 can be served by means of just one channel 24, so that a wetting of the glass inner side 20 of the sight glass 18 with the medium as far as possible over its full surface area is possible. It can also be seen that the inlet opening 26 of the channel 24 on the frame outer edge 36 has a connecting branch 52, by way of which a connecting unit with the medium can be connected. The connecting branch 52 has a valve, so that the feeding of the medium into the channel 24 can be controlled by means of the valve.

FIG. 4 also illustrates the arrangement of the sight glass 18 in the frame device 16. The frame device 16 has a frame outer side 54, which is arranged parallel to and at a distance from the frame inner side 32. The frame outer side 54 is facing away from the wall region 34 of the pipe end portion 12 surrounding the opening 14 when the sight glass cover 10 is placed on the opening 14. A profiling 56 for receiving the sight glass 18 is formed in the transitional region between the frame outer side 54 and the frame inner edge 38. The sight glass 18 lies with a peripheral region of the glass edge 57 in the profiling. A seal 58 is formed between the peripheral region of the glass edge 57 and the profiling. The sight glass 18 is usually adhesively bonded in the profiling 56 or is provided with a sealing ring cut to size for this.

The frame device 16 has a number of bores 60, which extend from the frame outer side 54 to the frame inner side 32 and are in each case designed for receiving a fastening means 62. The sight glass cover 10 is flange-mounted on the pipe end portion 12 by way of the fastening means 62 and by means of a flange 64. The sight glass 20 is in this case additionally fixed by means of the flange 64.

FIG. 5 shows a horizontal section through the frame device 16 of the sight glass cover 10 shown in FIG. 4. This horizontal section illustrates the just one channel 24, which extends from the frame outer edge 36 to the frame inner edge 38 and opens out into the distributor channel 50 of the nozzle frame 44 arranged on the inner edge 38. Like the frame device 16, the nozzle frame 44 is formed as a circular ring. The distributor channel 50 is formed on the nozzle frame outer edge 48 as running around radially peripherally.

The nozzles 42 are arranged on the perimeter of the nozzle frame inner edge 46 at regular intervals from one another and extend from the distributor channel 50 to the nozzle frame inner edge 46. The nozzles 42 are arranged offset in relation to the channel 24. In this way, a medium introduced into the channel 24 by way of the inlet opening 26 flows into the distributor channel 50. From there, the medium flows into the nozzles 42. The arrangement of the nozzles 42 offset in relation to the channel 24 enforces a distribution of the medium in the distributor channel, so that the plurality of nozzles 42 are activated. Consequently, a wetting of the glass inner side of the sight glass (which cannot be seen in this section) as far as possible over its full surface area can be accomplished and cleaning of the glass inner side as far as possible over its full surface area can be achieved.

### DESIGNATIONS

10 sight glass cover
12 pipe end portion
14 opening
16 frame device
18 sight glass
20 glass inner side
22 cleaning device
24 channel
26 inlet opening
28 outlet opening
30 medium
32 frame inner side
34 wall area
36 frame outer edge
38 frame inner edge
40 nozzle device
42 nozzle
44 nozzle frame
46 nozzle frame inner edge
48 nozzle frame outer edge
50 distributor channel
52 connecting branch
56 profiling
57 glass edge
58 seal
60 bore
62 fastening means
64 flange

1. A sight glass cover with an integrated cleaning device, for closing an opening, comprising
a sight glass, which has a glass edge and a glass inner side, wherein the glass inner side is facing the opening when a sight glass cover is placed on the opening, and
a frame device, which encloses the sight glass at least in the region of the glass edge, wherein the frame device has a frame inner side, which is facing away from the glass inner side and lies against a wall region surrounding the opening when a sight glass cover is placed on the opening,
a cleaning device, which is formed in the frame device and has at least one channel with an inlet opening and an outlet opening at a distance from the inlet opening, wherein the outlet opening of the channel is formed between the glass inner side and the frame inner side, and the channel is designed and formed in such a way that the glass inner side of the sight glass can be at least partially wetted with a medium fed into the channel by way of the inlet opening and leaving by way of the outlet opening.

2. The sight glass cover as claimed in claim 1, wherein the frame device has a frame outer edge and a frame inner edge at a distance from the frame outer edge, wherein,
the frame inner edge is facing the sight glass and the frame outer edge is facing away from the sight glass, and
the channel runs from the frame outer edge to the frame inner edge, and
the inlet opening is formed on the frame outer edge, and
the outlet opening is formed on the frame inner edge.

3. The sight glass cover as claimed in claim 2, wherein the channel is formed from the frame outer edge to the frame inner edge in a straight line.

4. The sight glass cover as claimed in claim 1, wherein the inlet opening of the channel has a connecting branch.

5. The sight glass cover as claimed in claim 2, wherein the outlet opening of the channel has on the frame inner edge a nozzle device with a nozzle.

6. The sight glass cover as claimed in claim 5, wherein the nozzle device has a nozzle frame with a distributor channel and a plurality of nozzles connected to the distributor channel, and
the nozzle frame is arranged and/or fastened on the frame inner edge in such a way that the outlet opening of the channel arranged on the frame inner edge opens out into the distributor channel, and
the nozzles are arranged and formed in such a way that the glass inner side of the sight glass can be at least partially wetted with a medium fed in by way of the inlet opening and leaving by way of the nozzles.

7. The sight glass cover as claimed in claim 6, wherein the nozzle frame has a nozzle frame inner edge and a nozzle frame outer edge at a distance from the nozzle frame inner edge, and the nozzle frame is arranged with its nozzle frame outer edge at least partially on the frame inner edge, and the nozzle frame inner edge is facing away from the frame inner edge, and
the distributor channel is optionally formed as running around peripherally on the nozzle frame outer edge, and
the plurality of nozzles respectively run from the distributor channel to the nozzle frame inner edge.

8. The sight glass cover as claimed in claim 5, wherein the distributor channel formed in the nozzle frame outer edge is a peripheral groove or a peripheral hollow fillet.

9. The sight glass cover as claimed in claim 6, wherein the outlet opening of the channel and the nozzles of the nozzle frame are arranged offset in relation to one another.

10. The sight glass cover as claimed in claim 1, wherein the glass inner side of the sight glass has a level surface, and the channel and/or the outlet opening and/or the nozzle is arranged and/or aligned with respect to the glass inner side at an angle (α) of between 10°≤α≤60°.

11. The sight glass cover as claimed in claim 1, wherein the frame device is formed as circular.

12. The sight glass cover as claimed in claim 2, wherein the frame device has a frame outer side, which is arranged at a distance from the frame inner side and is facing away from the wall region surrounding the opening when a sight glass cover is placed on the opening, and a profiling is formed in a transitional region between the frame outer side and the frame inner edge, wherein the profiling is designed and formed for receiving the sight glass at least partially, optionally in a peripheral region of the glass edge.

13. The sight glass cover as claimed in claim 1, wherein the frame device has a plurality of channels.

14. The sight glass cover as claimed in claim 1, wherein the plurality of nozzles are arranged on the perimeter of the nozzle frame inner edge and/or the plurality of outlet openings are arranged on the perimeter of the frame device at regular intervals in relation to one another.

15. A sight glass cover with an integrated cleaning device as claimed in claim 1 for closing an opening in a vessel and/or pipe of a chemical production plant.
